(19) United States
(12) Patent Application Publication
(10) Pub. No.: US 2003/0053828 A1
(43) Pub. Date: Mar. 20, 2003

(54) Image forming apparatus

(76) Inventors: Masahiro Yagi, Chiyoda (JP); Kazutaka Sato, Kashiwa (JP); Kenji Asuwa, Toride (JP); Isao Nakajima, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/228,051

(22) Filed: Aug. 27, 2002

(30) Foreign Application Priority Data
Sep. 18, 2001 (JP) 2001-282577

(51) Int. Cl. G03G 15/01

(52) U.S. Cl. 399/301

(57) ABSTRACT

An image forming apparatus comprising imaging units arranged alternately on both sides of continuous paper characterized by minimized image misregistration and reduced processing cost. In order to prevent possible color misregistration caused by changes in paper feed path length resulting from the eccentricity of each drive roller, the difference of eccentric phases of rollers on the front and back surfaces is controlled, thereby minimizing the difference of changes in paper feed path length.

### BACKGROUND OF THE INVENTION

1. Field of the Invention

The present invention relates to an image forming apparatus.

2. Prior Art

A commonly used image forming apparatus for printing an color image on both sides of a page of a book or the like is a tandem type duplex color image forming apparatus wherein multiple image forming unit for forming a monochromatic image on an image carrier are arranged on both sides of continuous form (hereinafter referred to as “web recording medium”) and the monochromatic image formed by each image forming unit is transferred onto an intermediate transfer member or directly onto the web recording medium, whereby a color image is formed.

The above stated tandem type duplex color image forming apparatus is configured as shown in FIG. 1, for example.

On one side of the web recording medium, monochromatic image forming units for black (hereinafter referred to as “K”), yellow (hereinafter referred to as “Y”), magenta (hereinafter referred to as “M”) and cyan (hereinafter referred to as “C”) are arranged in the forward feed direction of the web recording medium. Similarly on the other side, monochromatic image forming units for K, Y, M and C are arranged in the forward feed direction of paper. These image forming units are arranged in a staggered form on both sides of the paper at the first glance.

In this image forming apparatus, four image forming units are overlapped on a transfer medium for one web recording medium, thereby forming a color image.

However, when eccentricity due to installation conditions of various rotary bodies and eccentricity due to clearance error of the rotary shafts of these rotary bodies has occurred, image forming misregistration appears as color misregistration among different color toner images. They will lead to deterioration of image quality. To ensure high image quality, some measures must be taken to reduce the image forming misregistration.

To solve these problems, various proposals have been disclosed.

For example, these proposals can be broadly classified into the following two types of art: one is based on the art of adjusting the rotary phase of the roller, and the other is based on the art of adjusting the rotary phase of the drum-shaped image carrier to a specified phase.

The first art of adjusting the rotary phase of the roller is disclosed in Japanese Application Patent Laid-Open Publication No. Hei 10-20604.

This prior-art image forming apparatus is configured to ensure relative adjustment of the rotary phase of the image carrier of each image forming unit in order to avoid overlapping between peaks of the vibration components of periodic rotational changes that may be caused by roller eccentricity.

The second prior art for adjusting the rotary phase of a drum to a specified phase is disclosed in Japanese Application Patent Laid-Open Publication No. Hei 10-333398.

This prior-art image forming apparatus is configured to detect the misregistration in mapping with respect to point caused by irregular speed of the drive system including a belt and drum, and to ensure a specific relationship between the drum rotational position detected by a drum position sensor and the transfer position on the belt.

In the case of an image forming apparatus based on the above stated first prior art, it is necessary to use a rotary body position sensor for detecting the color misregistration pattern or reading the permeable marker having a high degree of permeability, for example, a CCD sensor with multiple photodetecting pixels arranged in a linear form using transmitted light, or a magnetically permeable belt position sensor.

Further, in the case of an image forming apparatus based on the above stated second prior art, some measures must be taken to prevent misregistration caused by eccentricity resulting from staggered layout since image forming units are arranged on one side.

In the above stated first and second prior arts, a pattern or marker is provided on the image carrier of the intermediate transfer member or the endless belt. This requires a rotary body position sensor for reading the pattern or marker, and fails to cut down costs and to improve productivity—a common problem to these types of prior art.

### SUMMARY OF THE INVENTION

The object of the present invention is to provide a high-precision image forming apparatus suited for use in high-speed printing.

The above object can be achieved by providing an image forming apparatus comprising: first detecting means for detecting the eccentricities of rollers, calculating means for calculating the optimum phase difference of the adjacent ones out of the above stated rollers from the above stated first detecting means, and second detecting means for detecting the eccentric phase of the above stated rollers from the above stated optimum phase difference, wherein the above stated optimum phase difference and the above stated eccentric phase maintain the optimum phase difference among the adjacent rollers.

The above object can also be achieved by providing an image forming apparatus comprising multiple image forming means for forming monochromatic images wherein the above stated image forming means are arranged alternately on both sides of a recording medium, and the above stated monochromatic images are overlapped on the above stated recording medium whereby an multicolored image is formed; the above stated image forming apparatus characterized by further comprising; means for detecting the eccentric phase of the first of the rotary bodies where the periodic changes of the path of the above stated recording medium is minimized by the eccentricity of the rotary bodies of the above stated image forming means for determining the feed path of the above stated recording medium, and means for detecting the eccentric phase of the above stated second rotary body and calculating the phase difference, wherein the second rotary body adjacent to the above stated first rotary body is turned to hold the above stated phase difference.

The above object can also be achieved by providing an image forming apparatus wherein means for determining the feed path of the above stated recording medium is made of a non-rotary member.

The above object can be achieved by providing an image forming apparatus comprising plural image forming means for forming a respective monochromatic image, and said image forming means are arranged alternatively on both faces of a recording medium, and said monochromatic images are overlapped on said recording medium, whereby a multiple color image is formed, said image forming apparatus comprises further, wherein a first detecting means for detecting an eccentricity of each of rollers, a second detecting means for detecting an eccentric phase of each of said rollers, and a calculating means for an optimum eccentricity phase difference of adjacent rollers among said rollers according to said first detecting means, thereby said optimum eccentricity phase difference among said adjacent rollers is maintained.

### BRIEF DESCRIPTION OF THE DRAWINGS

FIG. 1 is an explanatory diagram representing the configuration of the apparatus according to the present invention;

FIG. 2 is an explanatory diagram representing the configuration of the apparatus according to the present invention and the calculation of the path length between transfer points;

FIG. 3 is a block diagram representing a control circuit;

FIG. 4 is a diagram representing a control flow chart;

FIG. 5 is an explanatory diagram representing the calculation of a transfer point;

FIG. 6 is an explanatory diagram representing the calculation of the path length between a transfer point and a winding start point;

FIG. 7 is an explanatory diagram representing the calculation of winding start point;

FIG. 8 is an explanatory diagram representing the minimum change in the path length between transfer points;

FIG. 9 is an explanatory diagram representing the relationship between the rotation phase of each roller and path length between transfer points;

FIG. 10 is an explanatory diagram representing the relationship between difference of rotation phase and difference of changes in path length between transfer points;

FIG. 11 is an explanatory diagram representing the relationship between difference of rotation phase of each roller subsequent to modification of conditions and path length between transfer points; and

FIG. 12 is an explanatory diagram representing the relationship between difference of rotation phase subsequent to modification of conditions and difference of changes in path length between transfer points.

### DETAILED DESCRIPTION OF THE INVENTION

If the drive roller in indirect contact with continuous recording medium is high-precision roller free of eccentricity, then it is possible to get an image forming apparatus characterized by the minimum color misregistration. From the viewpoint of cost saving, however, it is not realistic to manufacture all the derive rollers characterized by high precision.

As described above, it is not realistic to provide control by utilizing a rotary body position sensor as in the above stated prior art, for example, a CCD sensor with multiple photodetecting pixels arranged in a linear form using transmitted light, or a magnetically permeable belt position sensor, because such a method leads to higher costs.

To solve these problems, the present invention provides an image forming apparatus free of color misregistration by using a drive roller having the conventional precision and controlling in such a way that a constant length is maintained at all times between the transfer points of the drive roller.

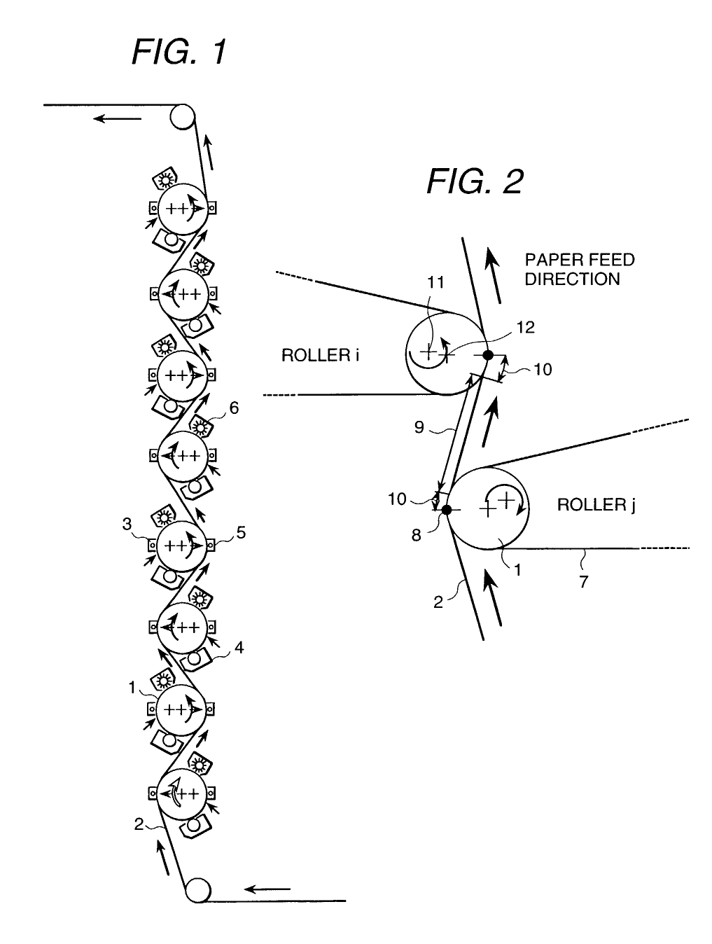

The following describes the overview of an image forming apparatus according to the present invention with reference to FIG. 1:

In FIG. 1, numeral 1 denotes a roller for driving the image forming unit that forms an monochromatic image on an image carrier, and 5 shows an exposure device for exposing image data on a belt-shaped image carrier (hereinafter referred to as “image carrier”). Numeral 4 indicates a developer for attaching toner on the image carrier as will be described later with reference to FIG. 2, and 3 denotes a transfer device for transfer the toner of the image carrier onto the web recording medium 2. Numeral 6 shows a cleaner for remove the residual toner from the image carrier after transfer operation. These image forming members are collectively called an image forming unit.

The above stated image forming units are placed on one side of the web recording medium, in the order of black (hereinafter referred to as “K”), yellow (hereinafter referred to as “Y”), magenta (hereinafter referred to as “M”) and cyan (hereinafter referred to as “C”) . Similarly on the other side, they are arranged in the order of K, Y, M and C. These image forming units are arranged in a so-called staggered form on both sides of the paper.

FIG. 2 is an enlarged view of the image forming unit.

In FIG. 2, the drive roller 1 shown in FIG. 1 is represented as rollers i and j. Numeral 7 denotes a belt-shaped image carrier. Numeral 8 indicates a transfer point for transferring toner from the image carrier 7 in roller j onto the recording medium 2, and 8 denotes the length from the point where the recording medium 2 starts to wind around the roller i to the point where terminates winding around the roller j. Numeral 9 denotes the length from the transfer point of each of rollers i and j to the point where winding starts, and 11 represents the center of rotation for the rollers i and j that are eccentric. Numeral 12 shows the central points of rollers i and j.

The length of the path between transfer points as a total of the above stated path lengths 9 and 10 are calculated in the following order:

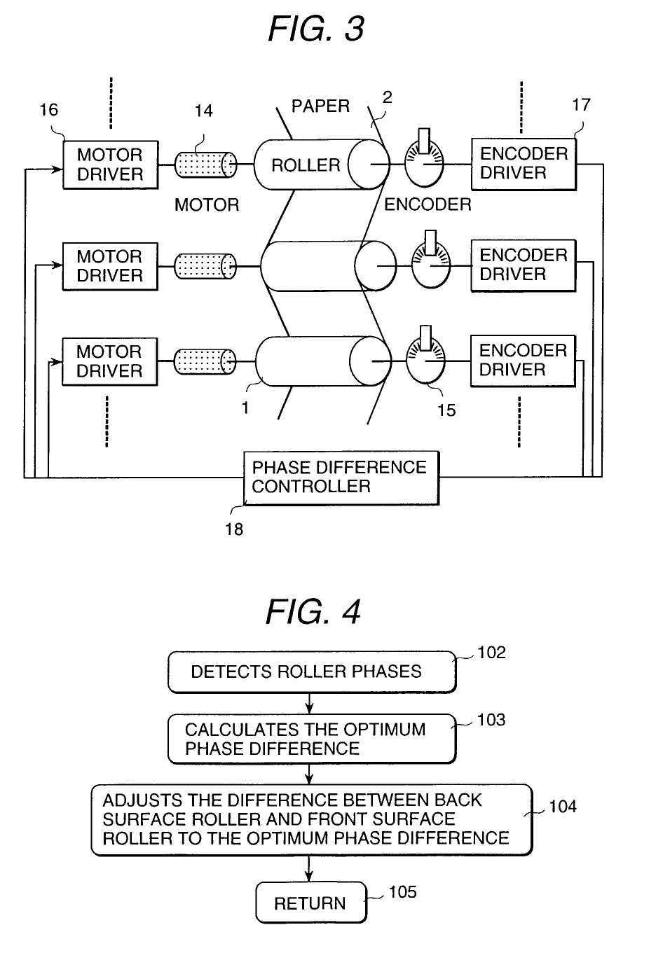

The following describes the control configuration of the present invention with reference to FIG. 3:

FIG. 3 is a block diagram representing a control circuit.

In FIG. 3, numeral 14 denotes a motor for driving the drive roller. Numeral 15 shows an encoder for measuring the roller drive speed, and 16 shows the dive circuit for the above stated motor 14. Numeral 17 denotes a circuit of the above stated encoder 15, and 18 are a phase control circuit. This phase control circuit is used to keep changes in the length of the path between transfer points to a minimum level by maintaining the difference in the rotation phases of rollers at 160° at all times.

The phase control circuit 18 given in FIG. 13 will be explained with reference to the flow chart in FIG. 4:

In FIG. 4, the phase of each drive roller is detected in Step 102. The optimum phase of the drive roller is calculated from the detected phase in Step 103.

In Step 104, the phase is adjusted to the motor for driving the drive roller according to the optimum phase calculated in Step 102.

To give further description, the rotation phase of each roller is detected using the information coming from each encoder circuit in Step 102. In Step 103, from the rotation phase detected in Step 102 the optimum rotation phase of each driver is calculated according to the calculation formula to be described later. In response to the calculated optimum rotation phase, the drive motor for driving the drive roller is controlled in Step 104. The processes in Steps 102 to 104 are always repeated in Step 105.

In the present embodiment, the phase control circuit provides control to maintain the drive circuit of each roller at a phase difference of 160°.

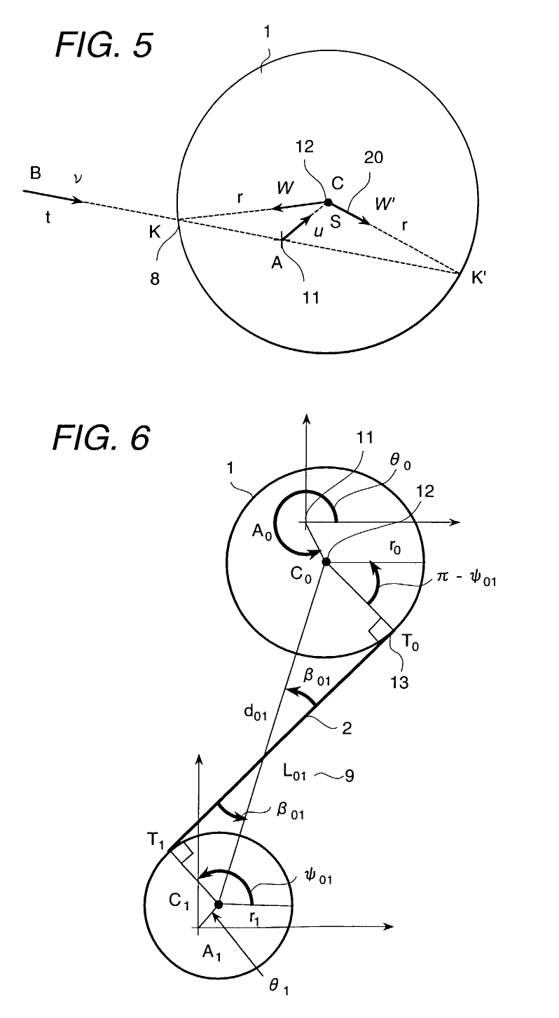

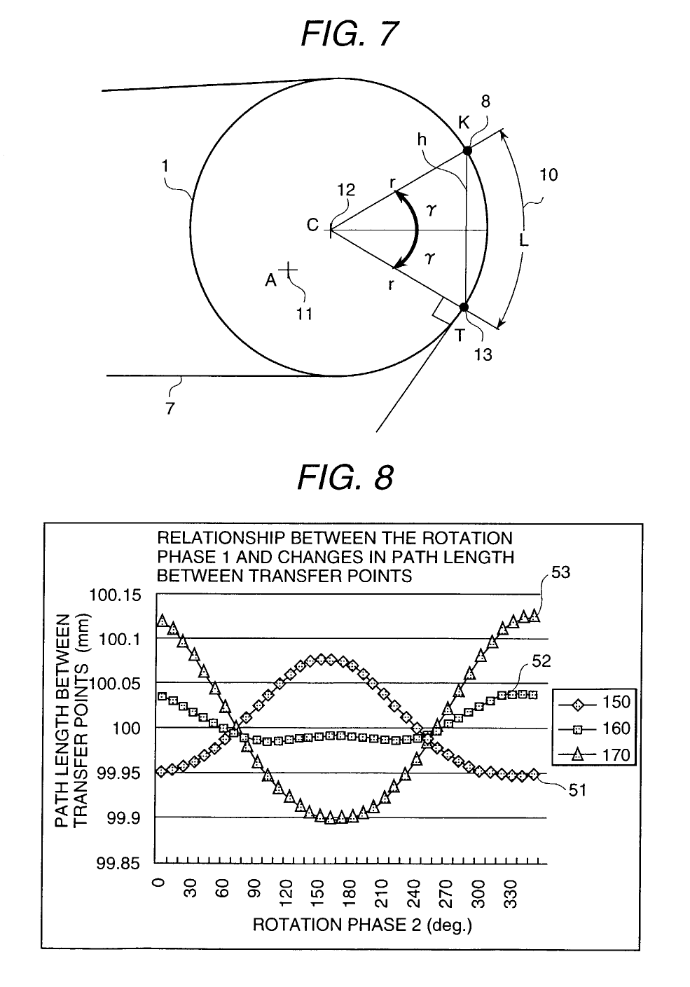

In Step 103 shown in FIG. 4, the details for calculating the transfer point on the roller will be described with reference to FIG. 5, and the details of calculating the point of starting the winding of continuous paper will be explained with reference to FIG. 6. Further, the details of calculating the distance from the point of starting winding between rollers to the transfer point are also described using FIG. 7. Use of this calculation clarifies the relationship between the difference of rotation phase of the roller and path length between transfer points.

In FIG. 5, numeral 11 indicates the rotation center of the eccentric roller 1, and 12 denotes the original rotational center point of the roller 1. Numeral 8 represents a transfer point where toner is transferred from the image carrier 7 in roller 1 onto the recording medium 2, and 20 shows the amount of eccentricity of roller 1.

The transfer point on the above stated roller 1 can be obtained from the following formulae (1) to (4):

K=A+su+rw, K=B+tv, u·v=0, |w|=1

From these formulae, the following formulae can be derived in the final stage:

Ax=roller rotation axis, x-axis position

Ay=roller rotation axis, y-axis position

Ai=(Axi, Ayi)

Bxi=transfer device position, x-axis position

Byi=transfer device position, y-axis position

Bi=(Bxi, Byi)

Cx=roller center point, x-axis point

Cy=roller center point, y-axis point

Ci=(Cxi, Cyi)

Ki=transfer point, x-axis position

Ki=transfer point, y-axis position

U=unit vector from point A to point C

V=unit vector from point B to point K

W=unit vector from point C to point K

r=distance of straight line CK

s=distance of straight line AC

t=distance of straight line BK

W=Pt+Q, P=v/r, Q=((B−A)−((B−A)·u)u)/r

In other words, (1) t=(−P·Q±((P·Q)2−|P|2 (|Q|2−1))0.5/|P|2

From the above stated formula (1), two solutions of “t” are obtained. The smaller of the two indicates the point K, and the larger one the point K′. Accordingly, the transfer point 8 on the side with paper wound thereon represents the point K where the value is smaller.

In FIG. 6, numeral 13 denotes the point where winding of continuous paper 2 as recording medium starts. To calculate the point 13 where winding of continuous paper 2 starts, the distance between roller center points d01=((Ax0−Ax1)2+(Ay0−Ay1)2)0.5 and length from the roller i winding start point to the roller j winding end point 9: L01=(d012−(r0+r1)2)0.5 is calculated. Then continuous paper winding start point T is calculated by obtaining angle β.

β01=sin−1((r0−r1)/d01)

ψ01=π/2−β01+tan−1((C0y−C1y)/(C0x−C1x)

T1x=C1x+r1·cos ψ01

T1y=C1y+r1·sin ψ01

T0x=C0x+r0·cos(π−ψ01)

T0y=C0y−r0·sin(π−ψ01)

Tx=continuous paper winding start point, x-axis position

Ty=continuous paper winding start point, y-axis position

Ti=(Txi, Tyi) (2)

When calculating the distance between the roller-to-roller winding start point 13 and transfer point 8 in FIG. 7, the length L=2γr from the transfer point K to the winding start point T must be calculated according to the following formula and “h”:

γ=sin−1(h/2r)

h=((Kx−Tx)2+(Ky−Ty)2)0.5 (3)

As described above, the continuous paper winding length between roller transfer points L total=L0+L1+L01 can be calculated.

Based on the formulae (1), (2) and (3), a combination of optimum roller rotation phases capable of reducing the changes in the path length between transfer points is obtained, and phase adjustment is performed. The following values are substituted into these formulae to find the changes in the path length between transfer points resulting from the difference in roller rotation phase. (It should be noted that “1.0 unit” is assumed to be one tenth of the roller radius, or the same as the amount of eccentricity).

i=1

j=2

θ1=0° to 360°

θ2=0° to 360°

r1=10.0 unit

r2=10.0 unit

e1=1.0 unit

e2=1.0 unit

E1=(0.0, 100.0) unit

E2=(0.0, 0.0) unit

In FIG. 8, numeral 51 denotes a path length between transfer points when the rotation phase 1 is 150° and the rotation phase 2° is 0° to 360°. Numeral 52 represents a path length between transfer points when the rotation phase 1 is 160° and the rotation phase 2 is 0° to 360°, and numeral 53 indicates a path length between transfer points when the rotation phase 1 is 170° and the rotation phase 2 is 0° to 360°. Changes in the path length between transfer points are the smallest when the rotation phase is 160°, as is apparent from FIG. 8. Changes in the path length between transfer points can be reduced from 0.05 unit (where θ1=160°, and θ2=0° to 360°) to 2.04 unit to 2.04 unit (where θ1=340°, and θ2=0° to 360°) by combinations of rotation phases.

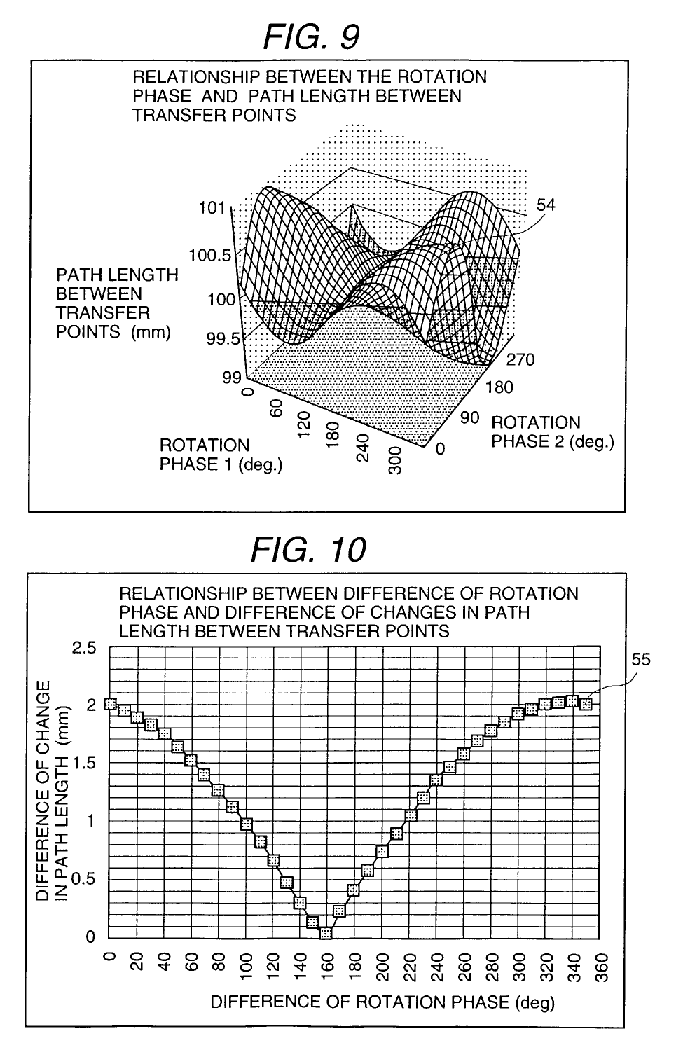

In FIG. 9, numeral 54 indicates the maximum path length between transfer points. As shown in FIG. 7, it is apparent that the maximum value 54 (101.01 units) of the path length between transfer points is produced by a combination of the rotation phase of θ1=80°, and θ2=350°, while the minimum value (98.97 units) is caused by a combination of the rotation phase of θ1=260°, and θ2=340°.

In FIG. 10, numeral 55 denotes the relationship between difference of changes in path length between transfer points and difference of rotation phases. It can be seen that the change in the path length between transfer points is kept to a minimum when the difference of rotation phases of two adjacent rollers is 160°.

However, when conditions are different from the above, the difference of rotation phases for the minimum change in path length between transfer points is not 160°.

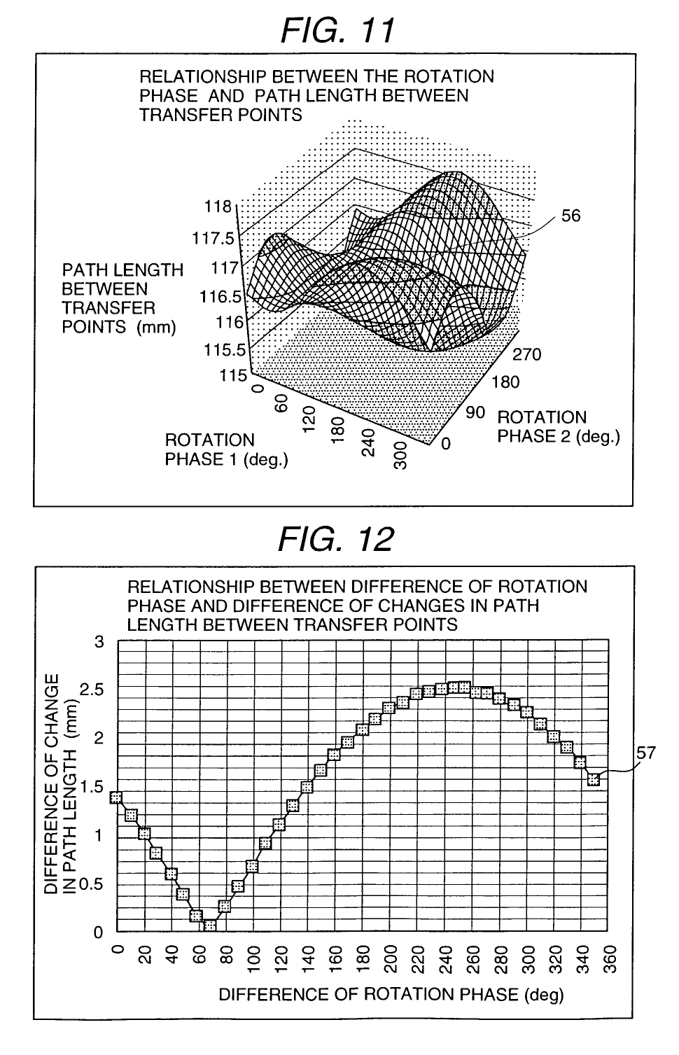

For example, in cases where E1=(50.0, 100.0) unit and E2=(0.0, 0.0) unit (other conditions remain the same), it can be seen that the numeral 56 represents the maximum path length between transfer points in FIG. 11, and, as shown in FIG. 11, the maximum path length between transfer points is different from that in FIG. 9.

In FIG. 12, numeral 57 denotes the relationship between difference of changes in path length between transfer points and difference of rotation phase. As can be seen by comparison between FIGS. 10 and 12, the minimum change in the path length between transfer points is changed from 160° to about 70°. Accordingly, differences of rotation phase for the minimum change in the path length between transfer points can be calculated under various conditions, using the above stated formula.

The present invention provides an image forming apparatus suitable for high-precision high-speed printing.

What is claimed is:

1. An image forming apparatus comprising:
first detecting meansfor detecting the eccentricities of rollers,
calculating means for calculating the optimum phase difference of the adjacent ones out of said rollers from said first detecting means, and
second detecting means for detecting the eccentric phase of said rollers from said optimum phase difference;
said image forming apparatus, wherein
said optimum phase difference and said eccentric phase maintains said optimum phase difference among the adjacent rollers.

2. An image forming apparatus comprising multiple image forming means for forming monochromatic images wherein said image forming means are arranged alternately on both sides of a recording medium, and said monochromatic images are overlapped on said recording medium whereby a multicolored image is formed;
said image forming apparatus further comprising, wherein
means for detecting the eccentric phase of the first of the rotary bodies where the periodic changes of the path of said recording medium is minimized by the eccentricity of the rotary bodies of said image forming means for determining the feed path of said recording medium, and
means for detecting the eccentric phase of said second rotary body and calculating the phase difference, wherein the second rotary body adjacent to said first rotary body is turned to hold said phase difference.

3. An image forming apparatus according to claim 2, wherein
means for determining the feed path of said recording medium is made of a non-rotary member.

4. In image forming apparatus comprising plural image forming means for forming a respective monochromatic image, and said image forming means are arranged alternatively on both faces of a recording medium, and said monochromatic images are overlapped on said recording medium, whereby a multiple color image is formed,
said image forming apparatus comprises further, wherein
a first detecting means for detecting an eccentricity of each of rollers,
a second detecting means for detecting an eccentric phase of each of said rollers, and
a calculating means for an optimum eccentricity phase difference of adjacent rollers among said rollers according to said first detecting means,
thereby said optimum eccentricity phase difference among said adjacent rollers is maintained.
